(19) United States
(12) Patent Application Publication
(10) Pub. No.: US 2006/0195372 A1
(43) Pub. Date: Aug. 31, 2006

(54) Automatic transfer of balance between balance sheet accounts

(76) Inventors: Kimberly A. Nelson, Fargo, ND (US); Kevin M. Magarian, Fargo, ND (US); Ronald H. Schulz, West Fargo, ND (US); Donald Dean Nelson, Moorhead, MN (US); Brett M. Lindemann, Fargo, ND (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(21) Appl. No.: 11/065,922

(22) Filed: Feb. 25, 2005

(51) Int. Cl. G07B 17/00; G07F 19/00

(52) U.S. Cl. 705/30

(57) ABSTRACT

A method of recording financial data is provided. The method includes establishing a first balance sheet account having a balance. The first balance sheet account is associated with a second balance sheet account. The method further includes automatically transferring the balance on the first balance sheet account to the second balance sheet account at a specified time.

### BACKGROUND OF THE INVENTION

The present invention relates to software systems for financial management of businesses. In particular, the present invention relates to associating and transferring balances among balance sheet accounts.

Businesses have typically used a variety of mechanisms to control and analyze business operations such as accounting, payroll, human resources, sales orders, employee tracking, customer relations tracking, etc. Tools which provide these functions are often implemented using computer software. A software package may provide a user interface in order for a user to easily enter and view data corresponding to the various business operations. The software packages are also configured to access and update the data, which is stored in a database.

A general ledger is a store house for financial activity and history (accounting information) of a company. Currently, a number of different ledger software systems are available for storing accounting information. Financial reporting tools, which access and report information from general ledger databases, are widely known in the art and are widely available in the consumer market. These reporting tools are valuable in the preparation of periodic financial statements.

Often, these reporting tools are used to adhere to particular accounting standards. Two of these standards are the Generally Accepted Accounting Principals (GAAP) and the International Account Standards (IAS). According to GAAP and IAS, only profit and loss account types should close out their balance to calculate earnings at the end of a fiscal year for reporting purposes. In other words, all profit and loss accounts start with a balance of zero at the beginning of a new year. Businesses typically create so-called balance sheet accounts to track financial activity directed to a particular asset, liability, project or task. These balance sheet accounts provide valuable data concerning the net worth of a business on a detailed level. Similar to the situation with profit and loss accounts, it is desirable that these detailed balance sheet accounts have their balance transferred to summary balance sheet accounts at periodic times, including period-end closing. Transferring the balance for these balance sheet accounts to the appropriate balance sheet account at periodic times in current financial management systems can be cumbersome and time consuming.

### SUMMARY OF THE INVENTION

A method of recording financial data is provided. The method includes establishing a first balance sheet account having a balance. The first balance sheet account is associated with a second balance sheet account. The method further includes automatically transferring the balance on the first balance sheet account to the second balance sheet account at a specified time.

### BRIEF DESCRIPTION OF THE DRAWINGS

FIG. 1 is a diagram of an exemplary computing environment.

FIG. 2 is a block diagram of balance sheet accounts in a general ledger.

FIG. 3 is a flow diagram of a method for associating balance sheet accounts.

FIG. 4 is an exemplary user interface for establishing a balance sheet account closing association.

### DETAILED DESCRIPTION OF ILLUSTRATIVE EMBODIMENTS

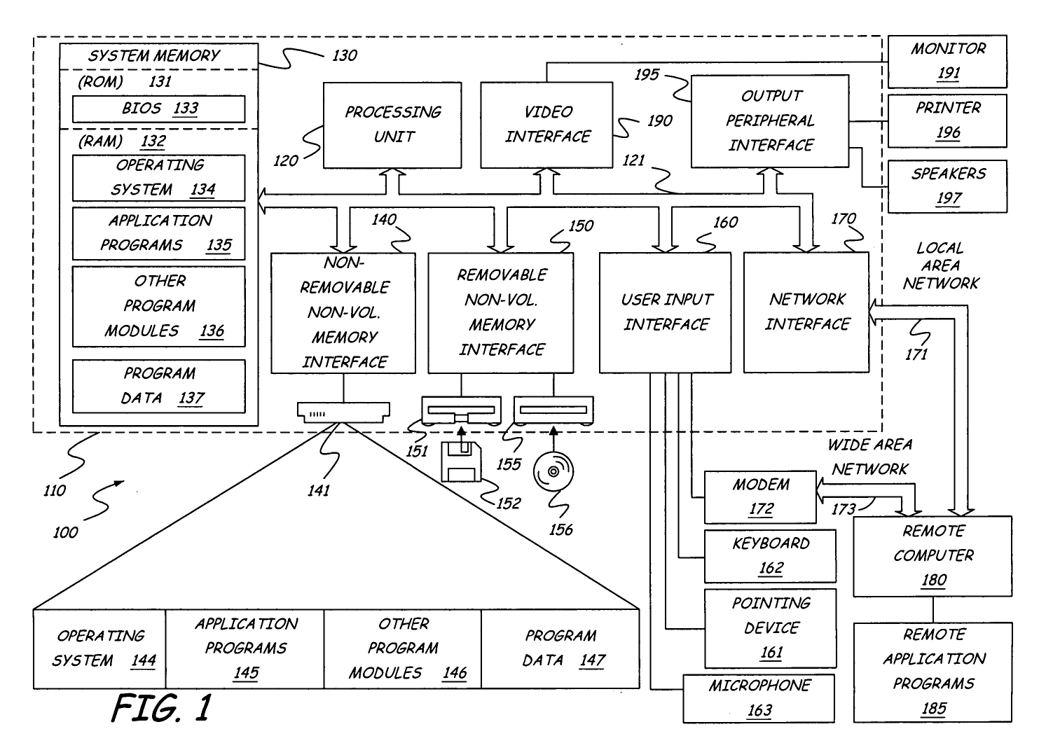

The present invention relates to managing financial data in a computing environment. Before describing the invention in more detail, one exemplary environment in which the present invention can be used will be discussed. FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 100. Communication media typically embodies computer readable instructions, data structures, program modules or other data in a modulated data signal such as a carrier WAV or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, FR, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user-input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

It should be noted that the present invention can be carried out on a computer system such as that described with respect to FIG. 1. However, the present invention can be carried out on any computerized financial system such as a server, a computer devoted to message handling, or on a distributed system in which different portions of the present invention are carried out on different parts of the distributed computing system.

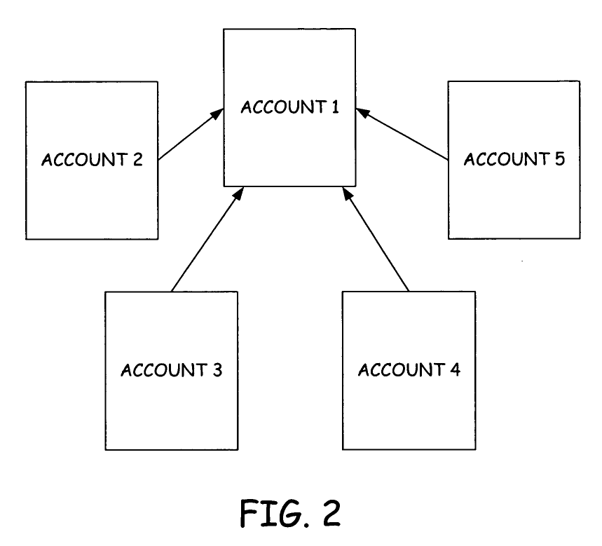

FIG. 2 is a schematic diagram of balance sheet accounts in a general ledger. Account 1 is a general or summary balance sheet account while Accounts 2-5 are detail balance sheet accounts. Periodically, for reporting purposes, balances for Accounts 2-5 are transferred to Account 1. For example, Account 1 can be a cash account and Accounts 2-5 track various activity related to the cash account. Similarly, Account 1 can be a building account and Accounts 2-5 can track various activities associated with the building account, such as work in process and materials.

Within a financial management system, Accounts 2-5 are associated with Account 1. This association is represented by arrows pointing from each of Accounts 2-5 to Account 1. As a result of this association, balances for Accounts 2-5 will be transferred to Account 1 upon initiation of a transfer process. The transfer process can be performed manually by a user or automatically at a specified time, for example at the end of a fiscal year. It will be appreciated that the association can be maintained such that the transfer process can be performed multiple times so a user does not have to continue specifying an association between balance sheet accounts multiple times. Furthermore, a user may choose to sever the association.

The transfer process includes closing a balance sheet account for year-end reporting. For example, a cash balance sheet account can be denoted with account number 1100. A dimension can be set up for the cash account to track transactions in various categories. The dimension adds a further level of detail to the cash account and a number of detail balance sheet accounts can be set up according to dimension codes. Exemplary codes, descriptions and balances for these balance sheet accounts are as follows:

| CODE | DESCRIPTION | BALANCE |
|---|---|---|
| 01 | Collections from Customers | $5,500.00 |
| | | (Debit) |
| 02 | Payments to Suppliers | $6,045.00 |
| | | (Credit) |
| 03 | Payments for Operating Expenses | $4,300.00 |
| | | (Credit) |
| 04 | Income Taxes Paid | $1,000.00 |
| | | (Credit) |
| 05 | Payments for Long-Term | $0.00 |
| | Investments | |
| 06 | Proceeds from the Disposition of | $0.00 |
| | Long-Term Investments | |
| 07 | Proceeds from the Issuance of | $10,000.00 |
| | Long-Term Bonds | (Debit) |
| 08 | Payments for the Retirement of | $0.00 |
| | Long-Term Bonds | |
| 09 | Proceeds from the Disposition of | $2,200.00 |
| | Fixed Assets | (Debit) |
| 10 | Payments for the Acquisition of | $500.00 |
| | Fixed Assets | (Credit) |

In another example, a building balance sheet account denoted as account 1501 is a general account. Detail accounts associated with building account 1501 with descriptions and balances are shown below:

| ACCOUNT | DESCRIPTION | BALANCE |
|---|---|---|
| 4200 | Land | $4,000.00 (Debit) |
| 4400 | Work in Process | $2,500.00 (Debit) |
| 4600 | Materials | $7,000.00 (Debit) |

Upon initiation of a transfer process, the closing entry generated for each cash account (for example at year end) above would be as follows:

| ACCOUNT | DEBIT | CREDIT |
|---|---|---|
| 02-1100 | 6,045.00 | |
| 03-1100 | 4,300.00 | |
| 04-1100 | 1,000.00 | |
| 10-1100 | 500.00 | |
| 1100 | 5,855.00 | |
| 01-1100 | | 5,500.00 |
| 07-1100 | | 10,000.00 |
| 09-1100 | | 2,200.00 |

Similarly, the closing entry generated for each of the building accounts after the transfer process would be as follows:

| ACCOUNT | DEBIT | CREDIT |
|---|---|---|
| 1501 | 13,500.00 | |
| 4200 | | 4,000.00 |
| 4400 | | 2,500.00 |
| 4600 | | 7,000.00 |

The association of balance sheet accounts can also be used to calculate a balance when querying an account balance or printing a financial report, even if the transfer process has not been performed. For example, a query of balance sheet Account 1 would reflect a balance of its associated balance sheet accounts, namely Accounts 2-5, even if the transfer process has not been completed. Likewise, cash account 1100 and building account 1501 would reflect a balance calculated with their respective associated balance sheet accounts.

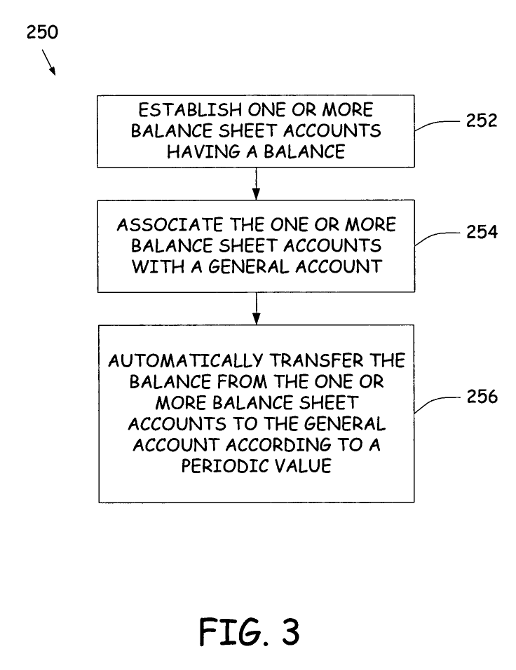

FIG. 3 illustrates an exemplary method 250 for setting up balance sheet accounts and associating the detailed balance sheet accounts with another balance sheet account. At step 252, one or more balance sheet accounts having a balance are established. For example, the balance sheet accounts mentioned above can be established in a financial software environment. At step 254, the one or more balance sheet accounts are associated with a general balance sheet account. For example, each balance sheet account can have a flag or other indicator to specify the associated general balance sheet account. The association can be created upon the creation of the balance sheet account or at a later time. Furthermore, as mentioned above, the association can be severed at a later time. At step 256, the balance from one or more balance sheet accounts is automatically transferred to the general balance sheet account according to a specified time. For example, the specified time can be manually set or the specified time can be based on periodic value. If the periodic value is yearly, the balances from the one or more balance sheet accounts are transferred to the general balance sheet account each year.

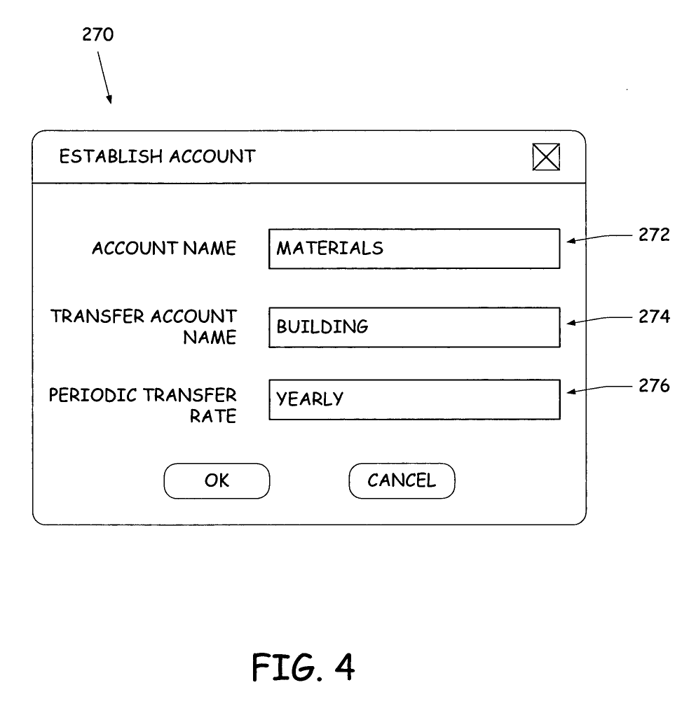

FIG. 4 is an exemplary user interface 270 for establishing a balance sheet account and associating the balance sheet account with another balance sheet account. User interface 270 includes an account name field 272, a transfer account field 274 and a periodic transfer rate field 276. Upon establishing an account, user interface 270 presents fields 272, 274 and 276 to a user. Fields 272, 274 and 276 can be used to associate the balance sheet account being created with another balance sheet account. In the embodiment illustrated, field 272 includes the account name “Materials”. Additionally, the user has specified the transfer account to be an account name “Building” in field 274. Additionally, the periodic value that has been established is “Yearly” in field 276, which specifies that the account “Materials” will have its balance transferred to the account “Building” each year.

Using the invention described above, a financial management system provides a convenient approach to associating balance sheet accounts with more general balance sheet accounts. As a result of the association, detailed accounts can have their respective balance automatically transferred to an associated account upon the initiation of a transfer process. This situation allows balance sheet accounts to easily be reset at year-end or at other times as desired.

Although the present invention has been described with reference to particular embodiments, workers skilled in the art will recognize that changes may be made in form and detail without departing from the spirit and scope of the invention.

What is claimed is:

1. A computer implemented method of recording financial information, comprising:
establishing a first balance sheet account having a balance;
associating the first balance sheet account with a second balance sheet account; and
automatically transferring the balance on the first balance sheet account to the second balance sheet account at a specified time.

2. The method of claim 1 and further comprising:
establishing a third balance sheet account;
associating the third balance sheet account with the second balance sheet account; and
transferring the balance on the third balance sheet account to the second balance sheet account at the specified time.

3. The method of claim 1 and further comprising:
automatically transferring the balance on the first balance sheet account to the second balance sheet account at a second specified time, later than the first-mentioned specified time.

4. The method of claim 1 and further comprising:
severing the association of the first balance sheet account with the second balance sheet account.

5. The method of claim 1 and further comprising:
establishing a periodic value for which to initiate automatically transferring the balance on the first balance sheet account to the second balance sheet account.

6. The method of claim 1 and further comprising:
requesting a balance for the second balance sheet account before automatically transferring the balance on the first balance sheet account to the second balance sheet account; and
calculating the balance on the second balance sheet account to include the balance on the first balance sheet account.

7. An application program for a computer readable medium, comprising:
an association module adapted to create an association between a first balance sheet account and a second balance sheet account; and
a transfer module adapted to automatically transfer a balance of the first balance sheet account to the second balance sheet account according to a periodic value.

8. The application program of claim 7 wherein the association module is further adapted to sever the association between the first balance sheet account and the second balance sheet account.

9. The application program of claim 7 and further comprising:
a user interface module adapted to allow a user to specify the first balance sheet account, the second balance sheet account and the periodic value.

10. The application program of claim 7 wherein the association module is further adapted to create an association between a third balance sheet account and the second balance sheet account and wherein the transfer module is further adapted to automatically transfer a balance of the third balance sheet account to the second balance sheet account according to the periodic value.
